(19) United States
(12) Patent Application Publication
(10) Pub. No.: US 2010/0310752 A1
(43) Pub. Date: Dec. 9, 2010

(54) Method for Enhancing Flavor of Drinks

(76) Inventor: Cheng-Hsueh Wu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/477,187

(22) Filed: Jun. 3, 2009

(51) Int. Cl. A23L 2/56; A23F 5/46; A23F 3/40

(52) U.S. Cl. 426/594; 426/590; 426/597

(57) ABSTRACT

A method for enhancing flavor of drinks has steps of making uncompleted whipped cream and enhancing flavor of a drink. The step of making uncompleted whipped cream includes stirring liquid fresh cream with salt to produce uncompleted whipped cream. The step of enhancing flavor of the drink includes adding the uncompleted whipped cream to the drink to make a salt drink with enhanced flavor.

### BACKGROUND OF THE INVENTION

1. Field of the Invention

The present invention relates to a method, and more particularly to a method for enhancing flavor of drinks.

2. Description of Related Art

Tea and coffee are popular drinks. Tea is refreshing and coffee is a stimulant.

To make drinks more appealing, various flavor enhancing methods have been developed. For example, adding milk or cream, honey or sugar. However, such conventional methods lack variation.

To overcome the shortcomings, the present invention tends to provide a method for enhancing flavor of drinks to mitigate or obviate the aforementioned problems.

### SUMMARY OF THE INVENTION

A method for enhancing flavor of drinks has steps of making uncompleted whipped cream and enhancing flavor of a drink. The step of making uncompleted whipped cream includes stirring liquid fresh cream with salt to produce uncompleted whipped cream. The step of enhancing flavor of the drink includes adding the uncompleted whipped cream to the drink to make a salt drink with enhanced flavor.

Other objects, advantages and novel features of the invention will become more apparent from the following detailed description when taken in conjunction with the accompanying drawings.

### BRIEF DESCRIPTION OF THE DRAWINGS

FIG. 1 shows operational perspective views of a first embodiment of a method for enhancing flavor of drinks in accordance with the present invention, illustrating a step of making uncompleted whipped cream;

FIG. 2 shows operational perspective views of the first embodiment of the method for enhancing flavor of drinks in accordance with the present invention, illustrating a step of enhancing flavor of a drink; and

FIG. 3 is a block diagram of the method for enhancing flavor of drinks in accordance with the present invention.

### DETAILED DESCRIPTION OF PREFERRED EMBODIMENT

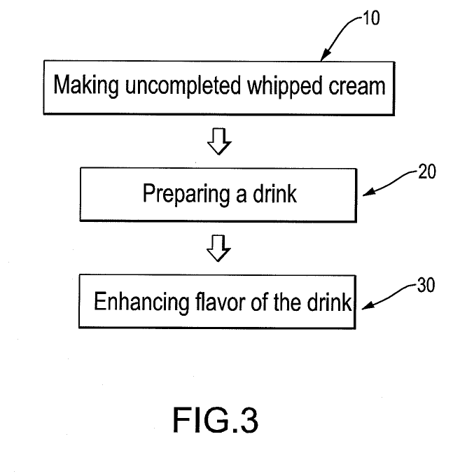

With reference to FIG. 3, a method for enhancing flavor of drinks in accordance with the present invention comprises steps of making uncompleted whipped cream (10), preparing a drink (20) and enhancing flavor of the drink (30).

The step of making uncompleted whipped cream (10) comprises steps of: adding a mixture of liquid fresh cream and salt into a stirrer, wherein a ratio of the salt and the liquid fresh cream is about 0.01g/cc; stirring the mixture liquid fresh cream at a specific speed range to make the uncompleted whipped cream, wherein a ratio of the liquid fresh cream to the uncompleted whipped cream is 1:1.7; and storing the uncompleted whipped cream in a refrigerator. The liquid fresh cream contains at least 20% butterfat, and preferably contains 36% butterfat. The stirrer may be a mechanical whisk.

The step of preparing the drink (20) may comprise steeping, stewing or infusing heated water with tea, coffee, fragrant plants, flavorings or the like, adding sweetener such as fructose sugar or the like and stirring the drink, wherein the volume of the drink is about 180 to 350 cc. The fragrant plants may be flower heads such as rose, lavender or the like; leaves such as rosemary, tea or the like; roots, such as ginger, ginseng or the like; or seeds or fruits, such as walnut, coffee or the like. The leaves, flower heads, roots, seeds or fruits may be dried before addition to water. The drink may be pre-prepared.

The step of enhancing flavor of the drink (30) comprises steps of: adding 30 to 40 g of the uncompleted whipped cream to the drink; and may comprise adding a garnish to the drink to make a salt drink. The garnish may be flavorings such as chocolate powder, nutmeg, cinnamon, green tea leaves, fragrant plants or the like.

### EXAMPLES

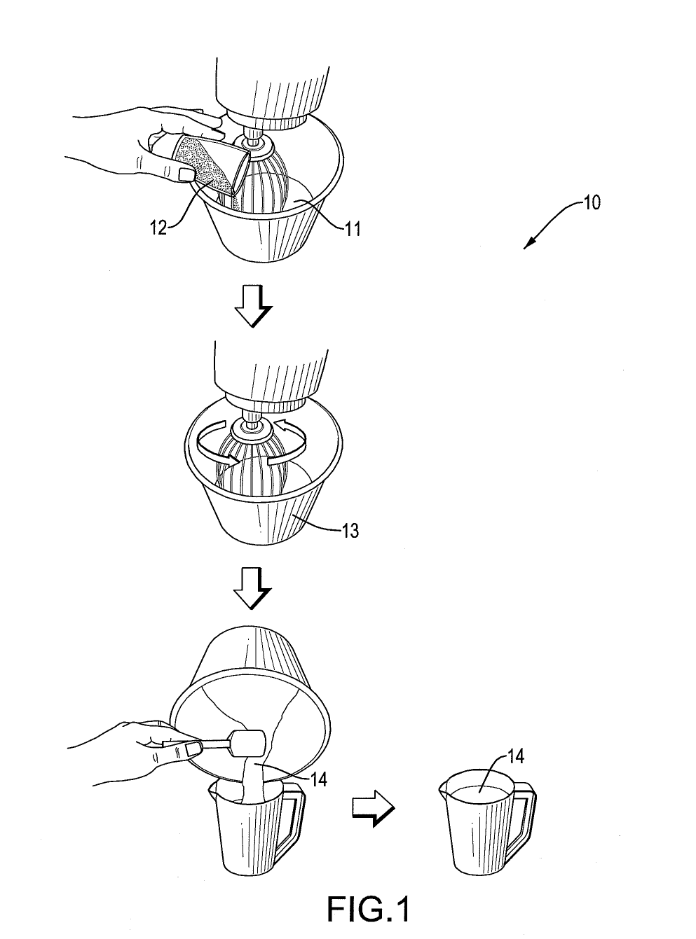

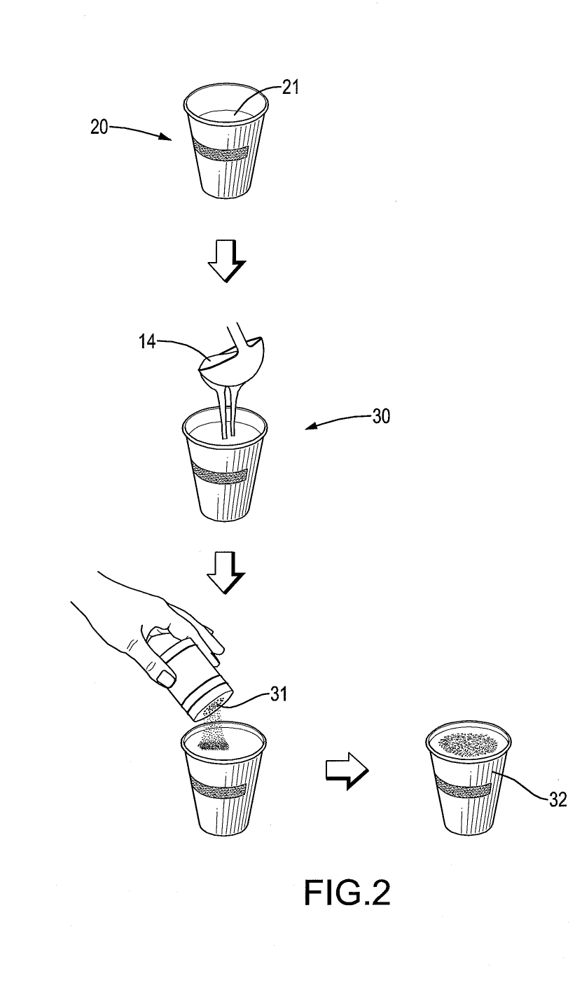

With reference to FIGS. 1, 2 and 3, the following examples further illustrate the present invention, but are not to be construed as limiting the invention as defined in the claims appended here to.

### Example 1

The step of making the uncompleted whipped cream (10) comprised adding 1000 cc of the liquid fresh cream (11) and 10 g salt (12) into the stirrer (13) and stirring at a specific speed range for 3 minutes to form 1700 cc of the uncompleted whipped cream (14). The uncompleted whipped cream (14) was then put into a container and stored in the refrigerator. The drink was iced coffee (21) and the step of making the drink comprised adding 150 cc water and 30 cc espresso coffee into a cup and adding ice to fill the cup by about eighty percent, adding 20 cc of fructose to the drink and stirring using the stir stick to make the iced coffee (21). The step of enhancing flavor of the drink (30) comprised adding 40 g of the uncompleted whipped cream (14) to the iced coffee (21) and garnishing with cocoa powder (31) to make an iced salt coffee (32).

### Example 2

The drink was heated coffee and the step of making the heated coffee comprised adding 300 cc heated water and 30 cc of the espresso coffee into a cup, adding 20 cc of fructose into the cup and stirring all ingredients by the stir stick to make heated coffee. The step of enhancing flavor of the drink comprised adding 40 g of the uncompleted whipped cream to the heated coffee and garnishing with 0.2 g of cocoa powder to make a heated salt coffee.

### Example 3

The drink was iced green and the step of making the iced green tea comprised adding 250 cc of green tea and 30 cc of the fructose into a cup, stirring with the stir stick and adding ice to fill the cup by about eighty percent to make the iced green tea. The step of enhancing flavor of the drink comprised adding 30 g of the uncompleted whipped cream to the iced green tea and garnishing with 0.2 g of green tea powder to make an iced salt green tea.

### Example 4

The drink was heated green tea and the step of making the heated green tea comprises heating 350 cc of the green tea to 55° C. by supplying steam, stopping supply of the stem and heating the green tea to 65-70° C. by previously supplied steam, adding 35 cc of the fructose to the heated green tea and stirring with the stir stick to make the heated green tea. The step of enhancing flavor of the drink comprised adding 30 g of the uncompleted whipped cream to the heated green tea and garnishing with 0.2 g of green tea powder to make a heated salt green tea.

### Example 5

The drink was iced oolong tea and the step of making the iced oolong tea comprised adding 250 cc of oolong tea and 30 cc of the fructose into a cup, with the stir stick and adding ice to fill the cup to about eighty percent to make the iced oolong tea. The step of enhancing flavor of the drink comprised adding 30 g of the uncompleted whipped cream to the iced oolong tea and garnishing with 0.2 g of green tea powder to make an iced salt oolong tea.

### Example 6

The drink was heated oolong tea and the step of making the heated oolong tea comprised heating 350 cc of the oolong tea to 55° C. by supplying steam, stopping supply of the stem and heating the oolong tea to 65-70° C. using previously supplied steam, adding 35 cc of fructose to the heated oolong tea and stirring using the stir stick to make the heated oolong tea. The step of enhancing flavor of the drink comprised adding 30 g of the uncompleted whipped cream to the heated oolong tea and garnishing with 0.2 g of green tea powder to make a heated salt oolong tea.

The uncompleted whipped cream containing salt improves taste and enhances flavor of the drinks, and mitigates bitterness of different kinds of tea.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for enhancing flavor of drinks comprising steps of:
making uncompleted whipped cream by stirring liquid fresh cream and salt; and
enhancing flavor of a drink by adding the uncompleted whipped cream to the drink to make a salt drink.

2. The method for enhancing flavor of drinks as claimed in claim 1, wherein the liquid fresh cream contains 36% butterfat.

3. The method for enhancing flavor of drinks as claimed in claim 2, wherein a ratio of the salt and the liquid fresh cream is 0.01 g/cc.

4. The method for enhancing flavor of drinks as claimed in claim 3, wherein a ratio of the liquid fresh cream and the uncompleted whipped cream is 1:1.7.

5. The method for enhancing flavor of drinks as claimed in claim 4, wherein the liquid fresh cream and the salt are stirred by a mechanical whisk.

6. The method for enhancing flavor of drinks as claimed in claim 5, wherein the uncompleted whipped cream is stored in a refrigerator.

7. The method for enhancing flavor of drinks as claimed in claim 6, wherein the method further comprises a step of the preparing the drink between the step of making the uncompleted whipped cream and the step of enhancing flavor of the drink.

8. The method for enhancing flavor of drinks as claimed in claim 7, wherein the drink is 180 to 350 cc.

9. The method for enhancing flavor of drinks as claimed in claim 8, wherein in the step of enhancing flavor of the drink, 30 to 40 g of the uncompleted whipped cream, is added to the drink.

10. The method for enhancing flavor of drinks as claimed in claim 9, wherein the step of enhancing flavor of the drink further comprises a step of garnishing the drink after adding uncompleted whipped cream to the drink.

11. The method for enhancing flavor of drinks as claimed in claim 9, wherein the drink is iced coffee.

12. The method for enhancing flavor of drinks as claimed in claim 9, wherein the drink is heated coffee.

13. The method for enhancing flavor of drinks as claimed in claim 9, wherein the drink is iced green tea.

14. The method for enhancing flavor of drinks as claimed in claim 9, wherein the drink is heated green tea.

15. The method for enhancing flavor of drinks as claimed in claim 9, wherein the drink is iced oolong tea.

16. The method for enhancing flavor of drinks as claimed in claim 9, wherein the drink is heated oolong tea.
